(19) United States
(12) Patent Application Publication
(10) Pub. No.: US 2024/0206558 A1
(43) Pub. Date: Jun. 27, 2024

(54) AEROSOL-GENERATING DEVICE HAVING PUFF RECOGNITION FUNCTION AND PUFF RECOGNITION METHOD THEREOF

(71) Applicant: KT&G CORPORATION, Daejeon (KR)

(72) Inventors: Seung Won LEE, Gyeonggi-do (KR); Dae Nam HAN, Seoul (KR); Dong Sung KIM, Seoul (KR); Yong Hwan KIM, Gyeonggi-do (KR); Seok Su JANG, Daejeon (KR)

(73) Assignee: KT&G CORPORATION, Daejeon (KR)

(21) Appl. No.: 18/288,894

(22) PCT Filed: Apr. 12, 2022
(86) PCT No.: PCT/KR2022/005242

§ 371 Date: Oct. 30, 2023

(30) Foreign Application Priority Data
Jun. 2, 2021 (KR) 10-2021-0071729

(51) Int. Cl. A24F 40/53; A24F 40/20; A24F 40/465; A24F 40/51; A24F 40/57

(52) U.S. Cl. CPC A24F 40/53; A24F 40/465; A24F 40/51; A24F 40/20; A24F 40/57

(57) ABSTRACT

An aerosol-generating device having a puff recognition function includes plurality of temperature sensors configured to detect a temperature change of an airflow path in the aerosol-generating device, and a controller configured to compare the detected temperature change with a threshold set for each of the plurality of temperature sensors when the temperature change is detected, and determine whether a user's puff occurred based on a comparison result.

### TECHNICAL FIELD

The present disclosure relates to an aerosol-generating device having a puff recognition function and a puff recognition method of the aerosol-generating device, and more particularly, to an aerosol-generating device capable of recognizing and counting user's puffs and a puff recognition method of the aerosol-generating device.

### BACKGROUND ART

Recently, the demand for alternative methods to overcome the disadvantages of traditional cigarettes has increased. For example, there is growing demand for an aerosol-generating device which generates an aerosol by heating an aerosol generating article (e.g., cigarette) including an aerosol generating material without combustion. Accordingly, researches on a heating-type aerosol-generating device has been actively conducted.

### DISCLOSURE

### Technical Problem

In general, an aerosol-generating device provides a smoking experience to a user through a predetermined number of puffs after power is turned on, and temporarily enters a standby mode or a charging mode when the predetermined number is exhausted. In general, heating-type aerosol-generating devices generate a low quality aerosol when an aerosol generating material is heated for an excessively long time, which is likely to happen due to their structural characteristics. Thus, in order to provide a user with an aerosol having consistent quality, it is desirable to accurately count the number of puffs of the user and temporarily stop heating a heater based on the counted number of puffs.

An objective of the present disclosure is to provide an aerosol-generating device capable of accurately recognizing a user's puff by using a temperature sensor.

### Technical Solution

An aerosol-generating device having a puff recognition function, according to an embodiment of the present disclosure, includes: a plurality of temperature sensors that detect a temperature change inside an airflow path in the aerosol-generating device; and a controller that compares the detected temperature change with a threshold set for each of the temperature sensors when the temperature change is detected, and determines whether a puff has been generated by a user based on a result of the comparison.

An aerosol-generating device having a puff recognition function, according to an embodiment of the present disclosure, includes: a plurality of temperature sensors that detect a temperature change inside an airflow path; and a controller that integrates the detected temperature changes of the plurality of temperature sensors, compares a result of the integration with a preset threshold, and determines whether a user's puff occurred based on a comparison result.

A puff recognition method of an aerosol-generating device, according to an embodiment of the present disclosure, includes: detecting, by plurality of temperature sensors, a temperature change inside an airflow path in the aerosol-generating device; when the temperature change is detected, comparing, by a controller, the detected temperature change with a threshold set for each of the plurality of temperature sensors; and determining, by the controller, whether a puff has been generated by a user based on a result of the comparison.

### Advantageous Effects

According to the present disclosure, the puff (i.e., inhalation) may be accurately recognized regardless of the unique characteristics of a user's inhalation action.

Furthermore, according to the present disclosure, an aerosol having a consistent quality may be provided to a user through accurate puff counting.

### DESCRIPTION OF DRAWINGS

FIGS. 1 and 2 are views illustrating examples in which a cigarette is inserted into an aerosol-generating device.

FIG. 3 is a view illustrating another example in which a cigarette is inserted into an aerosol-generating device.

FIG. 4 is a view illustrating an example of a cigarette.

FIG. 5 is a view illustrating another example of a cigarette.

FIG. 6 is a view illustrating an example of a double medium cigarette used in the aerosol-generating device of FIG. 3.

FIG. 7 is a perspective view of an example of an aerosol-generating device according to an embodiment of the present disclosure.

FIG. 8 is a side view of the aerosol-generating device described with reference to FIG. 7.

FIG. 9 is a schematic view illustrating a cross-section of an aerosol-generating device according to an embodiment of the present disclosure.

FIG. 10 is a perspective view of another example of an aerosol-generating device according to an embodiment of the present disclosure.

FIG. 11 is a graph showing a temperature change of a temperature sensor that detects a temperature change of air in an airflow path.

FIG. 12 is a view illustrating the number of remaining puffs output through an output unit of an aerosol-generating device according to an embodiment.

FIG. 13 is a flowchart of an example of a puff recognition method according to an embodiment of the present disclosure.

### BEST MODE

According to an aspect of the present disclosure, an aerosol-generating device having a puff recognition function includes: a plurality of temperature sensors that detect a temperature change of an airflow path in the aerosol-generating device; and a controller that compares the detected temperature change with a threshold set for each of the temperature sensors when the temperature change is detected, and determines whether a puff has been generated by a user based on a result of the comparison.

According to an aspect of the present disclosure, an aerosol-generating device having a puff recognition function includes: a plurality of temperature sensors that detect a temperature change inside an airflow path; and a controller that integrates the detected temperature changes of the plurality of temperature sensors, compares an integration result with a preset threshold, and determines whether a user's puff occurred based on a result of the comparison.

At least one of the plurality of temperature sensors may detect a temperature change of air in the airflow path.

At least one of the plurality of temperature sensors may detect a temperature change of a heater.

The heater may include a susceptor that is inductively heated by a coil through which an alternating current flows.

The plurality of temperature sensors may include at least one air temperature sensor configured to detect an air temperature change in the airflow path, and at least one heater temperature sensor configured to detect temperature change of a heater.

Each of the plurality of temperature sensors may include an air temperature sensor that detects a temperature change of air in the airflow path, wherein the air temperature sensor may be installed where a range of temperature change by a user's puff in the airflow path is 3 degrees to 5 degrees Celsius.

The aerosol-generating device may further include an output unit that visually outputs a number of remaining puffs, wherein the controller may determine whether a puff has occurred and controls the output unit to output the number of remaining puffs output.

The plurality of temperature sensors may detect a temperature change of air in the airflow path, and may selectively detect a change in air temperature exceeding a preset value.

According to an aspect of the present disclosure, a puff recognition method of an aerosol-generating device includes: detecting, by a plurality of temperature sensors, a temperature change inside an airflow path in the aerosol-generating device; when the temperature change is detected, comparing, by a controller, the detected temperature change with a threshold set for each of the plurality of temperature sensors; and determining, by the controller, whether a user's puff occurred based on a comparison result.

At least one of the plurality of temperature sensors may detect a temperature change of air in the airflow path.

At least one of the plurality of temperature sensors may detect a temperature change of a heater.

The plurality of temperature sensors may include at least one air temperature sensor configured to detect an air temperature change in the airflow path, and at least one heater temperature sensor configured to detect a temperature change of a heater.

The plurality of temperature sensors may include an air temperature sensor that detects a temperature change of air in the airflow path, wherein the temperature sensor is installed where a range of temperature change by a user's puff in the airflow path is 3 degrees to 5 degrees Celsius.

The plurality of temperature sensors may selectively detect a change in air temperature exceeding a preset value.

### MODE FOR INVENTION

With respect to the terms used to describe in the various embodiments, the general terms which are currently and widely used are selected in consideration of functions of structural elements in the various embodiments of the present disclosure. However, meanings of the terms can be changed according to intention, a judicial precedence, the appearance of a new technology, and the like. In addition, in certain cases, a term which is not commonly used can be selected. In such a case, the meaning of the term will be described in detail at the corresponding portion in the description of the present disclosure. Therefore, the terms used in the various embodiments of the present disclosure should be defined based on the meanings of the terms and the descriptions provided herein.

In addition, unless explicitly described to the contrary, the word “comprise” and variations such as “comprises” or “comprising” will be understood to imply the inclusion of stated elements but not the exclusion of any other elements. In addition, the terms “-er”, “-or”, and “module” described in the specification mean units for processing at least one function and operation and can be implemented by hardware components or software components and combinations thereof.

Hereinafter, the present disclosure will now be described more fully with reference to the accompanying drawings, in which exemplary embodiments of the present disclosure are shown such that one of ordinary skill in the art may easily work the present disclosure. The disclosure may, however, be embodied in many different forms and should not be construed as being limited to the embodiments set forth herein.

Hereinafter, embodiments of the present disclosure will be described in detail with reference to the drawings.

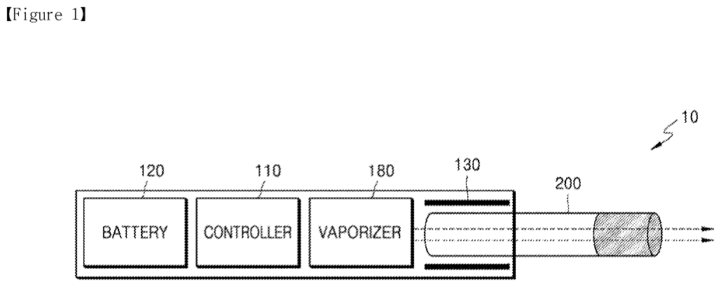

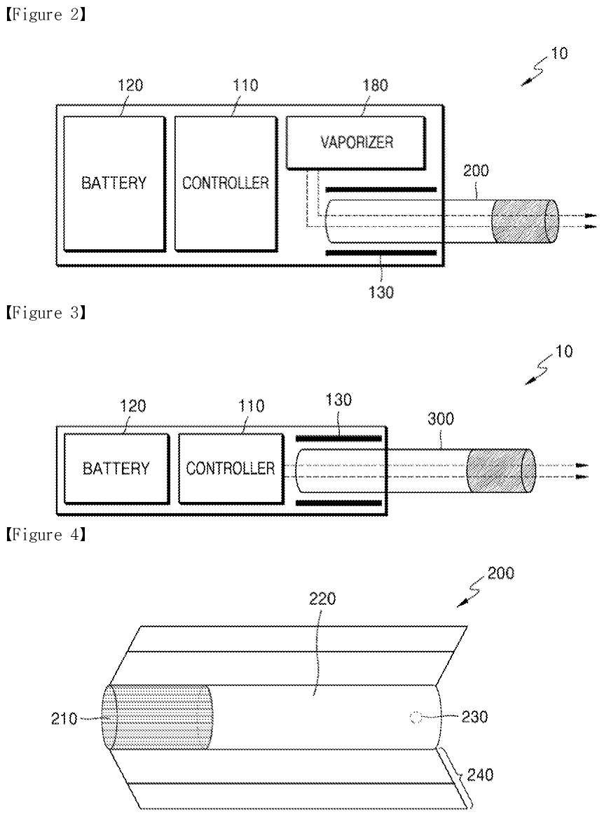

FIGS. 1 and 2 are diagrams showing examples in which an aerosol-generating article is inserted into an aerosol-generating device.

Referring to FIGS. 1 and 2, the aerosol-generating device 10 may include a battery 120, a controller 110, a heater 130 and a vaporizer 180. Also, cigarette 200 may be inserted into an inner space of the aerosol-generating device 10.

FIGS. 1 and 2 illustrate components of the aerosol-generating device 10, which are related to the present embodiment. Therefore, it will be understood by one of ordinary skill in the art related to the present embodiment that other general-purpose components may be further included in the aerosol-generating device 10, in addition to the components illustrated in FIGS. 1 and 2.

Also, FIGS. 1 and 2 illustrate that the aerosol-generating device 10 includes the heater 130. However, as necessary, the heater 130 may be omitted.

FIG. 1 illustrates that the battery 120, the controller 110, and the heater 130 are arranged in series. Also, FIGS. 1 and 2 illustrates that the vaporizer 180 and the heater 130 are arranged in parallel. However, the internal structure of the aerosol-generating device 10 is not limited to the structures illustrated in FIGS. 1 and 2. In other words, according to the design of the aerosol-generating device 10, the battery 120, the controller 110, the heater 130, and the vaporizer 180 may be differently arranged.

When cigarette 200 is inserted into the aerosol-generating device 10, the aerosol-generating device 10 may operate the vaporizer 180 to generate aerosol from the vaporizer 180. The aerosol generated by the vaporizer 180 is delivered to a user by passing through cigarette 200. A description of the vaporizer 180 will be given in more detail below.

The battery 120 may supply power to be used for the aerosol-generating device 10 to operate. For example, the battery 120 may supply power to heat the heater 130 or the vaporizer 180, and may supply power for operating the controller 110. Also, the battery 120 may supply power for operations of a display, a sensor, a motor, etc. mounted in the aerosol-generating device 10.

The controller 110 may generally control operations of the aerosol-generating device 10. In detail, the controller 110 may control not only operations of the battery 120, the heater 130, and the vaporizer 180, but also operations of other components included in the aerosol-generating device 10. Also, the controller 110 may check a state of each of the components of the aerosol-generating device 10 to determine whether or not the aerosol-generating device 10 is able to operate.

The controller 110 may include at least one processor. A processor can be implemented as an array of a plurality of logic gates or can be implemented as a combination of a general-purpose microprocessor and a memory in which a program executable in the microprocessor is stored. It will be understood by one of ordinary skill in the art that the processor can be implemented in other forms of hardware.

The heater 130 may be heated by the power supplied from the battery 120. For example, when cigarette 200 is inserted into the aerosol-generating device 10, the heater 130 may be located outside cigarette 200. Thus, the heated heater 130 may increase a temperature of an aerosol generating material in cigarette 200.

The heater 130 may include an electro-resistive heater. For example, the heater 130 may include an electrically conductive track, and the heater 130 may be heated when currents flow through the electrically conductive track. However, the heater 130 is not limited to the example described above and may include all heaters which may be heated to a desired temperature. Here, the desired temperature may be pre-set in the aerosol-generating device 10 or may be set by a user.

As another example, the heater 130 may include an induction heater. In detail, the heater 130 may include an electrically conductive coil for heating an aerosol-generating article in an induction heating method, and cigarette may include a susceptor which may be heated by the induction heater.

In FIGS. 1 and 2, the heater 130 is illustrated as being disposed outside the cigarette 200, but is not limited thereto. For example, the heater 130 may include a tube-type heating element, a plate-type heating element, a needle-type heating element, or a rod-type heating element, and may heat the inside or the outside of cigarette 200, according to the shape of the heating element.

Also, the aerosol-generating device 10 may include a plurality of heaters 130. Here, the plurality of heaters 130 may be inserted into cigarette 200 or may be arranged outside cigarette 200. Also, some of the plurality of heaters 130 may be inserted into cigarette 200 and the others may be arranged outside cigarette 200. In addition, the shape of the heater 130 is not limited to the shapes illustrated in FIGS. 1 and 2, and may include various shapes.

The vaporizer 180 may generate aerosol by heating a liquid composition and the generated aerosol may pass through cigarette 200 to be delivered to a user. In other words, the aerosol generated via the vaporizer 180 may move along an air flow passage of the aerosol-generating device 10 and the air flow passage may be configured such that the aerosol generated via the vaporizer 180 passes through cigarette 200 to be delivered to the user.

For example, the vaporizer 180 may include a liquid storage, a liquid delivery element, and a heating element, but it is not limited thereto. For example, the liquid storage, the liquid delivery element, and the heating element may be included in the aerosol-generating device 10 as independent modules.

The liquid storage may store a liquid composition. For example, the liquid composition may be a liquid including a tobacco-containing material having a volatile tobacco flavor component, or a liquid including a non-tobacco material. The liquid storage may be formed to be detachable from the vaporizer 180 or may be formed integrally with the vaporizer 180.

For example, the liquid composition may include water, a solvent, ethanol, plant extract, spices, flavorings, or a vitamin mixture. The spices may include menthol, peppermint, spearmint oil, and various fruit-flavored ingredients, but are not limited thereto. The flavorings may include ingredients capable of providing various flavors or tastes to a user. Vitamin mixtures may be a mixture of at least one of vitamin A, vitamin B, vitamin C, and vitamin E, but are not limited thereto. Also, the liquid composition may include an aerosol forming substance, such as glycerin and propylene glycol.

The liquid delivery element may deliver the liquid composition of the liquid storage to the heating element. For example, the liquid delivery element may be a wick such as cotton fiber, ceramic fiber, glass fiber, or porous ceramic, but is not limited thereto.

The heating element is an element for heating the liquid composition delivered by the liquid delivery element. For example, the heating element may be a metal heating wire, a metal hot plate, a ceramic heater, or the like, but is not limited thereto. In addition, the heating element may include a conductive filament such as nichrome wire and may be positioned as being wound around the liquid delivery element. The heating element may be heated by a current supply and may transfer heat to the liquid composition in contact with the heating element, thereby heating the liquid composition. As a result, aerosol may be generated.

For example, the vaporizer 180 may be referred to as a cartomizer or an atomizer, but it is not limited thereto.

The aerosol-generating device 10 may further include general-purpose components in addition to the battery 120, the controller 110, the heater 130, and the vaporizer 180. For example, the aerosol-generating device 10 may include a display capable of outputting visual information and/or a motor for outputting haptic information. Also, the aerosol-generating device 10 may include at least one sensor (a puff sensor, a temperature sensor, an aerosol-generating article insertion detecting sensor, etc.). Also, the aerosol-generating device 10 may be formed as a structure that, even when cigarette 200 is inserted into the aerosol-generating device 10, may introduce external air or discharge internal air.

Although not illustrated in FIGS. 1 and 2, the aerosol-generating device 10 and an additional cradle may form together a system. For example, the cradle may be used to charge the battery 120 of the aerosol-generating device 10. Alternatively, the heater 130 may be heated when the cradle and the aerosol-generating device 10 are coupled to each other.

Cigarette 200 may be similar to a general combustive cigarette. For example, cigarette 200 may be divided into a first portion including an aerosol generating material and a second portion including a filter, etc. Alternatively, the second portion of cigarette 200 may also include an aerosol generating material. For example, an aerosol generating material made in the form of granules or capsules may be inserted into the second portion.

The entire first portion may be inserted into the aerosol-generating device 10, and the second portion may be exposed to the outside. Alternatively, only a portion of the first portion may be inserted into the aerosol-generating device 10, or the entire first portion and a portion of the second portion may be inserted into the aerosol-generating device 10. The user may puff aerosol while holding the second portion by the mouth of the user. In this case, the aerosol is generated by the external air passing through the first portion, and the generated aerosol passes through the second portion and is delivered to the user's mouth.

For example, the external air may flow into at least one air passage formed in the aerosol-generating device 10. For example, opening and closing of the air passage and/or a size of the air passage formed in the aerosol-generating device 10 may be adjusted by the user. Accordingly, the amount and the quality of smoking may be adjusted by the user. As another example, the external air may flow into cigarette 200 through at least one hole formed in a surface of cigarette 200.

FIG. 3 is a view illustrating another example in which a cigarette is inserted into an aerosol-generating device 10.

When compared with the aerosol-generating device 10 described with reference to FIGS. 1 and 2, the aerosol-generating device 10 shown in FIG. 3 does not include the vaporizer 180. Instead, an element performing the function of the vaporizer 180 may be included in a double medium cigarette 300.

When the double medium cigarette 300 is inserted into the aerosol-generating device 10 shown in FIG. 3, the aerosol-generating device 10 may generate an aerosol, which may be inhaled by a user, by externally heating the double medium cigarette 300. The double medium cigarette 300 will be described in more detail below with reference to FIG. 6.

Hereinafter, the examples of cigarette 200 will be described with reference to FIG. 4.

FIG. 4 illustrates an example of the cigarette 200.

Referring to FIG. 4, cigarette 200 may include a tobacco rod 210 and a filter rod 220. The first portion described above with reference to FIGS. 1 and 2 may include the tobacco rod 210, and the second portion may include the filter rod 220.

FIG. 4 illustrates that the filter rod 220 includes a single segment. However, the filter rod 220 is not limited thereto. In other words, the filter rod 220 may include a plurality of segments. For example, the filter rod 220 may include a first segment configured to cool an aerosol and a second segment configured to filter a certain component included in the aerosol. Also, as necessary, the filter rod 220 may further include at least one segment configured to perform other functions.

Cigarette 200 may be packaged using at least one wrapper 240. The wrapper 240 may have at least one hole through which external air may be introduced or internal air may be discharged. For example, cigarette 200 may be packaged by one wrapper 240. As another example, cigarette 200 may be doubly packaged by two or more wrappers 240. For example, the tobacco rod 210 may be packaged by a first wrapper 241, and the filter rod 220 may be packaged by wrappers. In addition, the tobacco rod 210 and the filter rod 220 wrapped by an individual wrapper may be combined, and the entire cigarette 200 may be repackaged by the third wrapper. When each of the tobacco rod 210 or the filter rod 220 includes a plurality of segments, each segment may be packaged by wrappers. In addition, the entire cigarette 200 in which segments wrapped by individual wrappers are combined may be repackaged by another wrapper.

The tobacco rod 210 may include an aerosol generating material. For example, the aerosol generating material may include at least one of glycerin, propylene glycol, ethylene glycol, dipropylene glycol, diethylene glycol, triethylene glycol, tetraethylene glycol, and oleyl alcohol, but it is not limited thereto. Also, the tobacco rod 210 may include other additives, such as flavors, a wetting agent, and/or organic acid. Also, the tobacco rod 210 may include a flavored liquid, such as menthol or a moisturizer, which is injected to the tobacco rod 210.

The tobacco rod 210 may be manufactured in various forms. For example, the tobacco rod 210 may be formed as a sheet or a strand. Also, the tobacco rod 210 may be formed as a pipe tobacco, which is formed of tiny bits cut from a tobacco sheet. Also, the tobacco rod 210 may be surrounded by a heat conductive material. For example, the heat conductive material may be, but is not limited to, a metal foil such as aluminum foil. For example, the heat conductive material surrounding the tobacco rod 210 may uniformly distribute heat transmitted to the tobacco rod 210, and thus, the heat conductivity applied to the tobacco rod may be increased and taste of the tobacco may be improved. Also, the heat conductive material surrounding the tobacco rod 210 may function as a susceptor heated by the induction heater. Here, although not illustrated in the drawings, the tobacco rod 210 may further include an additional susceptor, in addition to the heat conductive material surrounding the tobacco rod 210.

The filter rod 220 may include a cellulose acetate filter. Shapes of the filter rod 220 are not limited. For example, the filter rod 220 may include a cylinder-type rod or a tube-type rod having a hollow inside. Also, the filter rod 220 may include a recess-type rod. When the filter rod 220 includes a plurality of segments, at least one of the plurality of segments may have a different shape.

The filter rod 220 may be formed to generate flavors. For example, a flavoring liquid may be injected onto the filter rod 220, or an additional fiber coated with a flavoring liquid may be inserted into the filter rod 220.

Also, the filter rod 220 may include at least one capsule 230. Here, the capsule 230 may generate a flavor or an aerosol. For example, the capsule 230 may have a configuration in which a liquid containing a flavoring material is wrapped with a film. For example, the capsule 230 may have a spherical or cylindrical shape, but is not limited thereto.

When the filter rod 220 includes a segment configured to cool the aerosol, the cooling segment may include a polymer material or a biodegradable polymer material. For example, the cooling segment may include pure polylactic acid alone, but the material for forming the cooling segment is not limited thereto. In some embodiments, the cooling segment may include a cellulose acetate filter having a plurality of holes. However, the cooling segment is not limited to the above-described example and is not limited as long as the cooling segment cools the aerosol.

Meanwhile, although not shown in FIG. 4, the cigarette 200 according to an embodiment may further include a front-end filter. The front-end filter may be located on one side of the tobacco rod 210 which is opposite to the filter rod 220. The front-end filter may prevent the tobacco rod 210 from being detached outwards and prevent the liquefied aerosol from flowing from the tobacco rod 210 into the aerosol-generating device (100 of FIGS. 1 and 3), during smoking.

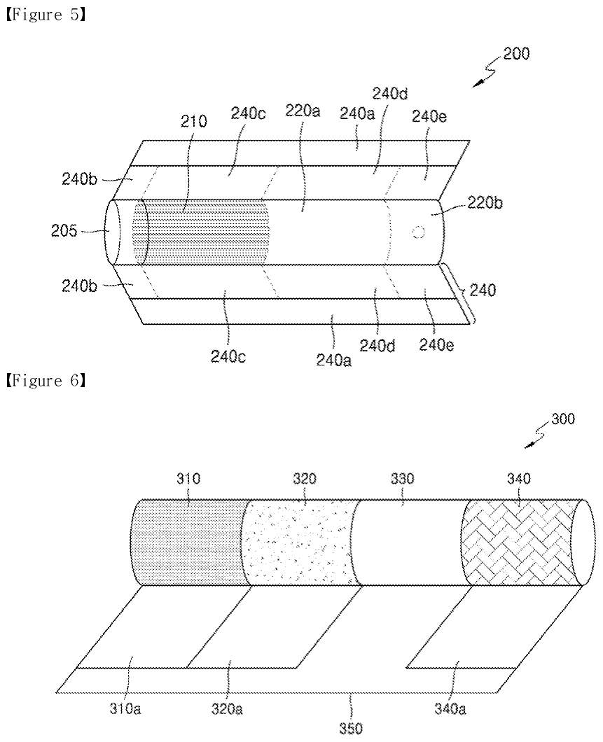

FIG. 5 is a view illustrating another example of the cigarette 200.

Referring to FIG. 5, the cigarette 200 may have a structure in which a cross tube 205, a tobacco rod 210, a tube 220a, and a filter 220b are sequentially arranged and wrapped by a final wrapper 240a. In FIG. 5, individual wrappers 240b, 240c, 240d, and 240e respectively surround the cross tube 205, the tobacco rod 210, the tube 220a, and the filter 220b, and the final wrapper 240a that wraps around the cross tube 205, the tobacco rod 210, the tube 220a, and the filter 220b respectively surrounded by the individual wrappers 240b, 240c, 240d, and 240e.

The first part described above with reference to FIGS. 1 and 2 includes the cross tube 205 and the tobacco rod 210, and the second part includes the filter 220b. For convenience of description, the following description will be made with reference to FIGS. 1 and 2, and the same description given above with reference to FIG. 4 will be omitted.

The cross tube 205 refers to a tube in the form of a cross, which is connected to the tobacco rod 210.

When the cigarette 200 is inserted into an aerosol-generating device, the cross tube 205 and the tobacco rod 210 may be sensed by a cigarette detection sensor. The cross tube 205 may be wrapped with a copper laminating paper wrapper which also wraps the tobacco rod 210, and may be used for the cigarette detection sensor to determine whether the cigarette 200 inserted is supported by the aerosol-generating device (e.g., whether the cigarette and the aerosol-generating device are manufactured by the same company).

The tobacco rod 210 includes an aerosol-generating material that is heated by the heater 130 of the aerosol-generating device 10 and generates an aerosol.

The tube 220a performs a function of transferring, to the filter 220b, an aerosol generated from the aerosol-generating material of the tobacco rod 210. The tube 220a be manufactured by adding triacetin (TA), i.e., a plasticizer, to cellulose acetate tow and molding the triacetin (TA) into a circle. When compared with the cross tube 205, the tube 220a has a different shape and arranged differently in that the tube 220a connects the tobacco rod 210 and the filter 220b.

When an aerosol generated by the tobacco rod 210 is delivered to the filter 220b through the tube 220a, the filter 220b passes the aerosol to allow a user to inhale the aerosol filtered by the filter 220b. The filter 220b may be a cellulose acetate filter manufactured based on cellulose acetate tow.

The final wrapper 240a is a paper surrounding each of the cross tube 205, the tobacco rod 210, the tube 220a, and the filter 220b, and may include a cross tube wrapper 240b, a tobacco rod wrapper 240c, a tube wrapper 240d, and a filter wrapper 240e.

In FIG. 5, for example, the cross tube wrapper 240b may include an aluminum material. The tube wrapper 240d surrounding the tube 220a may be a MFW or 24K wrapper, and the filter wrapper 240e surrounding the filter 220b may be an oil-resistant hard wrapper or a laminating paper having a poly lactic acid (PLA) material. The tobacco rod wrapper 240c and the final wrapper 240a will be described in more detail below.

The tobacco rod wrapper 240c surrounds the tobacco rod 210, and may be coated with a thermal conductivity improving material in order to maximize the efficiency of thermal energy transfer from the heater 130. For example, the tobacco rod wrapper 240c may be manufactured in a way that a general wrapper or a release base paper is coated with at least one of silver (Ag) foil paper, aluminum (Al) foil paper, copper (Cu) foil paper, carbon paper, filler, ceramic (e.g., AlN or Al2O3), silicon carbide, sodium citrate (e.g., Na citrate), potassium citrate (e.g., K citrate), aramid fiber, nano cellulose, mineral paper, glassine paper, and single-walled carbon nanotube (SWNT). The general wrapper refers to a wrapper widely used in cigarettes in the market, and may be a porous wrapper made of a material that has been tested for hand-made paper and has at least a certain level of paper manufacturing workability and thermal conductivity.

In addition, in the present disclosure, the final wrapper 240a may be manufactured in such a way that an MFW base paper is coated with at least one of filler, ceramic, silicon carbide, sodium citrate, potassium citrate, aramid fiber, nano cellulose, and SWNT, among various materials used for coating the tobacco rod wrapper 240c.

The heater 130 included in the externally heating-type aerosol-generating device 10 described with reference to FIGS. 1 and 2 is controlled by the controller 110 and heats the aerosol-generating material included in the tobacco rod 210 to generate an aerosol. In this case, thermal energy transferred to the tobacco rod 210 may be composed of 75% radiant heat, 15% convective heat, and 10% conduction heat. Depending on embodiments, the proportions of radiant heat, convective heat, and conduction heat constituting the thermal energy transferred to the tobacco rod 210 may vary.

In a case where the heater 130 does not directly contact the aerosol-generating material, it may be difficult to rapidly generate an aerosol. In this regard, according to an embodiment, a thermal conductivity improving material may be used for coating the tobacco rod wrapper 240c and the final wrapper 240a such that thermal energy may be efficiently transferred to the aerosol-generating material of the tobacco rod 210. Accordingly, a sufficient amount of aerosol may be provided to a user even during an initial puff before the heater 130 is sufficiently heated.

According to an embodiment, the thermal conductivity improving material may be used for coating only one of the tobacco rod wrapper 240c and the final wrapper 240a. Also, a material having at least a certain level of thermal conductivity, such as organic metal, inorganic metal, fiber, or polymeric material, may be used for coating the tobacco rod wrapper 240c or the final wrapper 240a.

FIG. 6 is a view illustrating an example of the double medium cigarette 300 used in the aerosol-generating device 10 of FIG. 3.

The double medium cigarette in FIG. 6 is different from the cigarettes shown in FIGS. 4 and 5 in that the aerosol generating material and the tobacco material are included in separate portions of the cigarette.

Referring to FIG. 6, the double medium cigarette 300 may have a structure in which an aerosol base portion 310, a medium portion 320, a cooling portion 330, and a filter portion 340 are sequentially arranged and wrapped by a final wrapper 350. In FIG. 6, the final wrapper 350 refers to an outer shell that surrounds individual wrappers 310a, 320a, and 340a which respectively surround the aerosol base portion 310, the medium portion 320, and the filter portion 340.

The aerosol base portion 310 may be made of pulp-based paper to which a moisturizing agent is added. The moisturizing agent (i.e., a basic material) contained in the aerosol base portion 310 may include propylene glycol and glycerin, which have a certain weight ratio with respect to the weight of a base paper. When the double medium cigarette 300 is inserted into the aerosol-generating device 10 of FIG. 3, the aerosol base portion 310 may generate moisturizing agent vapor when heated to or above a certain temperature.

The medium portion 320 includes at least one of a sheet, a strand, and pipe tobacco obtained by cutting a tobacco sheet into small pieces, and generates nicotine to provide a smoking experience to a user. The medium portion 320 may not be directly heated from the heater 130 even though the double medium cigarette 300 is inserted into the aerosol-generating device 10 of FIG. 3. Instead, the medium portion 320 may be indirectly heated by conduction, convection and radiation through the aerosol base portion 310 and a medium portion wrapper 320a (or a final wrapper 350) surrounding the medium portion 320, when they are heated. Specifically, the medium contained in the medium portion 320 needs to be heated to a lower temperature than the moisturizing agents contained in the aerosol base portion 310. In this regard, according to an embodiment, the medium portion 320 may be indirectly heated by the aerosol base portion 310 rather than by the heater 130 that is an external heating type heater. When the temperature of a medium included in the medium portion 320 rises to a temperature above a certain level, nicotine vapor is generated from the medium portion 320.

According to an embodiment, when the double medium cigarette 300 is inserted into the aerosol-generating device 10 of FIG. 3, a portion of the medium portion 320 may be positioned to face the heater 130 and thus may be directly heated by the heater 130.

The cooling portion 330 may be made of a tube filter containing a plasticizer having a certain weight. The moisturizing agent vapor and the nicotine vapor respectively generated from the aerosol base portion 310 and the medium portion 320 may be mixed and aerosolized, and then may be cooled while passing through the cooling portion 330. The cooling portion 330 may not be wrapped with an individual wrapper, unlike the aerosol base portion 310, the medium portion 320, or the filter portion 340.

The filter portion 340 may be a cellulose acetate filter, and the shape of the filter portion 340 is not limited. The filter portion 340 may be a cylinder-type type rod or a tube-type rod including a hollow therein. When the filter portion 340 is composed of a plurality of segments, at least one of the plurality of segments may be manufactured to have a different shape. The filter portion 340 may be manufactured to generate flavor. As an example, a flavoring liquid may be injected into the filter portion 340, and a separate fiber to which a flavoring liquid is applied may be inserted into the filter portion 340.

In addition, at least one capsule may be included in the filter portion 340. In this case, the capsule may perform a function of generating flavor. For example, the capsule may have a structure in which a liquid containing a fragrance is wrapped with a film, and may have a spherical or cylindrical shape, but is not limited thereto.

The cooling portion 330 may be made of a tube filter containing a plasticizer having a certain weight. The moisturizing agent vapor and the nicotine vapor respectively generated from the aerosol base portion 310 and the medium portion 320 may be mixed and aerosolized, and then may be cooled while passing through the cooling portion 330. The cooling portion 330 may not be wrapped with an individual wrapper, unlike the aerosol base portion 310, the medium portion 320, or the filter portion 340.

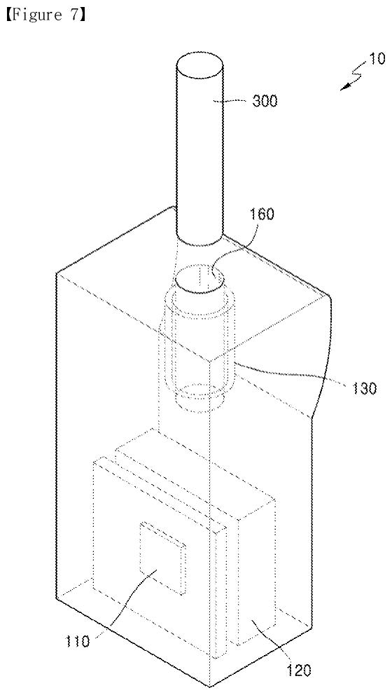

FIG. 7 is a perspective view of an example of an aerosol-generating device 10 according to an embodiment of the present disclosure.

Referring to FIG. 7, the aerosol-generating device 10 according to an embodiment of the present disclosure may include a controller 110, a battery 120, and a heater 130. The double medium cigarette 300 may be inserted into and heated by the aerosol-generating device 10 to generate an aerosol. For convenience of description, only some components of the aerosol-generating device 10 are highlighted and shown in FIG. 7. Thus, the aerosol-generating device 10 may include additional components without departing from the scope of the present disclosure.

In addition, the internal structure of the aerosol-generating device 10 is not limited to that shown in FIG. 7, and according to embodiments or designs, the arrangements of the controller 110, the battery 120, the heater 130, and the double medium cigarette 300 may vary. A description of each component of FIG. 7 will be omitted because it has already been described with reference to FIGS. 1 to 3.

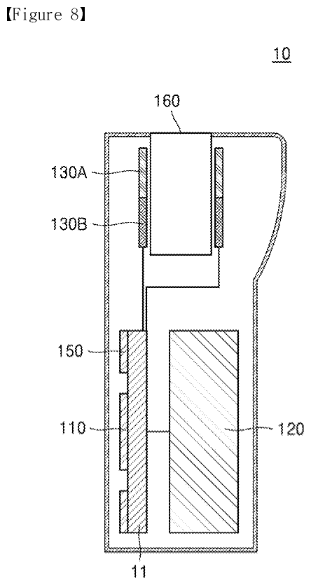

FIG. 8 is a side view of the aerosol-generating device 10 described with reference to FIG. 7.

Referring to FIG. 8, the aerosol-generating device 10 according to an embodiment of the present disclosure may include a printed circuit board (PCB) 11, a controller 110, a battery 120, a first heater 130A, a second heater 130B, a display 150, and a cigarette insertion space 160. Hereinafter, the same description provided above with reference to FIG. 1 will be omitted.

The PCB 11 may perform a function of electronically integrating various components that collect information of the aerosol-generating device 10 while communicating with the controller 110. The controller 110 and the display 150 may be fixedly mounted on the surface of the PCB 11, and the battery 120 for supplying power to devices connected to the PCB 11 may be connected to the surface of the PCB 11.

The first heater 130A and the second heater 130B respectively heat two medium portions of the double medium cigarette 300 to different temperatures, while the double medium cigarette 300 is inserted into the cigarette insertion space 160 of the aerosol-generating device of FIG. 8. The first heater 130A and the second heater 130B may be heated to different temperatures by including different materials, or by receiving different control signals from the controller 110 while including the same material.

The display 150 is a device for outputting visual information to a user, from among information generated by the aerosol-generating device 10. The display 150 may control, based on information received from the controller 110, information output to a display panel (e.g., liquid crystal display (LCD) panel or a light-emitting diode (LED) panel) provided on the front of the aerosol-generating device 10.

The cigarette insertion space 160 refers to a space for receiving the cigarette 200 or the double medium cigarette 300. The cigarette insertion space 160 may have a cylindrical shape so that the cigarette 200 or the double medium cigarette 300, which has the form of a stick, is stably mounted therein, and the height (depth) of the cigarette insertion space 160 may vary depending on the length of a region including an aerosol-generating material in the cigarette 200 or the double medium cigarette 300.

For example, when the double medium cigarette 300 described with reference to FIG. 6 is inserted into the cigarette insertion space 160, the height of the cigarette insertion space 160 may be equal to the sum of the length of the aerosol base portion 310 and the length of the medium portion 320. When the cigarette 200 or the double medium cigarette 300 is inserted into the cigarette insertion space 160, the first heater 130A and the second heater 130B, which are adjacent to the cigarette insertion space 160, may be heated, and thus, aerosols may be generated.

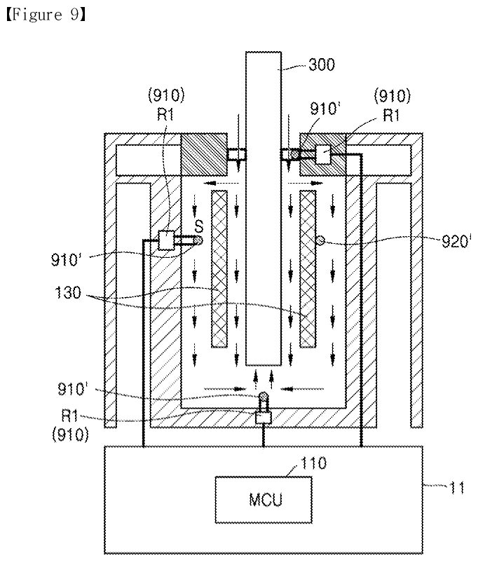

FIG. 9 is a schematic view illustrating a cross-section of an aerosol-generating device according to an embodiment of the present disclosure.

FIG. 9 is a diagram illustrating where the temperature sensor is positioned and how puff recognition of a microcontroller unit (MCU) (a controller) are implemented in the aerosol-generating device according to an embodiment of the present disclosure. In the center of FIG. 9, the double medium cigarette 300 shown in FIG. 6 is inserted into a cigarette insertion space, and the airflow occurring by a user's inhalation action is indicated by arrows around the cigarette insertion space. In this specification, unless specifically limited, the controller 100 is implemented by the MCU 110.

FIG. 9 shows a plurality of temperature sensors installed in an airflow path of airflow formed by a user's puff. The temperature sensors shown in FIG. 9 include a heater temperature sensor 920′ installed adjacent to a heater 130 to detect a temperature change of the heater 130 and an air temperature sensor for sensing a temperature change of the airflow path. Hereinafter, the heater temperature sensor 920′ may be referred to as a first temperature sensor, and the air temperature sensor may be referred to as a second temperature sensor. In another embodiment, unlike in FIG. 9, only a plurality of air temperature sensors may be installed in the airflow path without the air temperature sensor.

The heater temperature sensor 920′ is installed adjacent to the heater 130 to detect a temperature change of the heater 130 and transmits a detected result to the MCU 110. The MCU 110 may determine the current state of the heater 130 based on the temperature of the heater 130 received from the heater temperature sensor 920′. For example, the MCU 110 may determine whether the heater 130 is being preheated or whether the preheating of the heater 130 is completed, based on a temperature value or temperature change received from the heater temperature sensor 920′. In FIG. 9, the heater 130 may be a susceptor that is inductively heated by a coil through which an alternating current flows.

The air temperature sensor includes a temperature change sensing portion 910′ that is completely exposed to the airflow path to come into direct contact with the air inside the airflow path, and capable of detecting a change in temperature. Also, the air temperature sensor includes a variable resistor R1 (910) having resistance that varies depending on a temperature change detected by the temperature change sensing portion 910′. The variable resistor R1 may also serve to fix the position of the temperature change sensing portion 910′.

In addition, it is illustrated that air temperature sensors are installed at three locations in FIG. 9. However, the number of air temperature sensors is not limited to a certain number. According to embodiments, the number of air temperature sensors may be different from that shown in FIG. 9. In addition, the air temperature sensor installed in the airflow path may selectively detect only a temperature change greater than or equal to a preset value, thereby further improving the reliability of puff recognition.

In FIG. 9, when the aerosol-generating device is turned on and preheating of the heater 130 is completed, the temperature of the air in the airflow path is also stabilized to be constant. In this case, the temperature sensors installed in the airflow path use, as a reference (a threshold), the temperature of stabilized air after the preheating of the heater 130 is completed, and detect a temperature change of the air. Specifically, when a user puffs on the aerosol-generating device, external air flows into the airflow path. As a result, the temperature of the internal air of the airflow path is temporarily lowered. In addition, the temperature sensors changes the resistance of the variable resistor 910 based on the temperature change, and control the MCU 110 of the PCB 11 may recognize that a puff has occurred based on the resistance of the variable resistor 910. The variable resistor R1 of the temperature sensor may be one of a Negative Temperature Coefficient of Resistance (NTC) device and a Positive Temperature Coefficient of Resistance (PTC) device.

In FIG. 9, the air temperature sensor may be installed anywhere in the airflow path where the airflow is generated by a user's puff. The location where the airflow is generated through a user's puff may be experimentally, empirically, or mathematically determined. As the number of air temperature sensors increases, the accuracy of puff recognition may improve.

In addition, in order for the MCU 110 to accurately recognize a puff through information received from the air temperature sensor, it is preferable that the sensitivity of the air temperature sensor is higher than a certain level. Also, it is preferable to arrange the air temperature sensor at the most efficient location for puff recognition in the airflow path.

In an embodiment, the air temperature sensor may be installed at a location in the airflow path where the range of temperature change by a user's puff is 3 degrees to 5 degrees Celsius.

The temperature change by the user's puff in the airflow path is the greatest where the air circulating in the airflow path meets external air entering the airflow path. FIG. 9 shows a total of three air temperature sensors. Among them, a temperature change sensing portion S of the air temperature sensor is arranged near where external air meets internal air in the airflow path. Because the temperature change sensing portion S of the temperature sensor is arranged where a change in air temperature by a user's puff is the greatest, this temperature sensor may have the greatest influence on the puff recognition of the MCU 110.

As shown in FIG. 9, the remaining air temperature sensors are located at a point where the external air flows into the airflow path and a point where the air circulating in the airflow path enters the cigarette 300, respectively. Although the remaining air temperature sensors do not have as great an influence as the temperature sensor including the temperature change sensing portion S described above, the remaining air temperature sensors may influence the puff recognition of the MCU 110 by sensing the temperature change of the air inside the airflow path as a kind of sub-parameter.

An example of a process in which the MCU 110 determines that a puff has occurred through the three air temperature sensors of FIG. 9 will be described below in detail. First, the heater 130 heats the cigarette 300 (e.g., double medium cigarette) until the preheating is sufficiently performed so that an aerosol may be generated. The MCU 110 detects that the preheating of the heater 130 is completed through a heater temperature sensor 920′ or by another method, and controls the temperature of the heater 130 to be stably maintained according to a preset temperature profile. When a user inhales through the end of the double medium cigarette 300 while the temperature of the air inside the airflow path is stable, the temperature of the air inside the airflow path temporarily drops sharply. Accordingly, the plurality of temperature sensors installed in the airflow path may detect a temperature change and transmit the detected temperature change to the MCU 110.

When at least one temperature sensor among the plurality of temperature sensors does not detect a temperature change due to the different sensitivities or positions of the temperature sensors, the MCU 110 may determine that a puff has not occurred even though the remaining temperature sensors other than the at least one temperature sensor detect the temperature change. For example, the controller receives information on temperature change from all temperature sensors, compares the information with a threshold set for each temperature sensor, and comprehensively analyzes a comparison result to determine whether a puff has occurred.

In this case, the threshold for each temperature sensor is individually set according to the sensitivity of the temperature sensor and the position of the temperature sensor. For example, because a temperature sensor including the temperature change sensing portion S is installed at a location where the temperature change of the air is relatively great, a threshold for the temperature sensor including the temperature change sensing portion S may be greater than thresholds for the other temperature sensors. Individual thresholds of the plurality of temperature sensors may be stored in the form of a lookup table in a memory in the controller, and thus may be quickly loaded whenever necessary.

As described above, the MCU 110 determines that a puff has occurred when all of the threshold comparison results of the plurality of temperature sensors satisfy a preset condition, and determines that a puff has not occurred when any of the threshold comparison results of the plurality of temperature sensors does not satisfy the preset condition.

In another embodiment, the MCU 110 may not use a method in which an individual threshold is set for each temperature sensor and a comparison determination is performed as many times as the number of temperature sensors. Instead, the MCU 110 may integrate results detected by all air temperature sensors and compare the integrated results with a preset threshold to determine whether a puff has occurred. According to the this embodiment, even when one or more temperature sensors among the plurality of temperature sensors fail or malfunction, if the reliability of results detected by the remaining temperature sensors is sufficiently high, the MCU 110 may determine that a puff has occurred. Thus, in this case, the puff recognition of the MCU 110 is relatively less influenced by the failure of a temperature sensor.

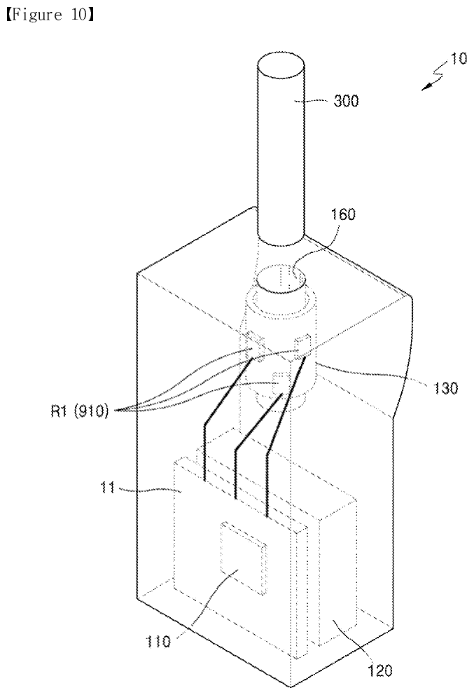

FIG. 10 is a perspective view of another example of an aerosol-generating device according to an embodiment of the present disclosure.

Referring to FIG. 10, it may be seen that a variable resistor R1 (910) is installed close to a cigarette insertion space 160 or a heater 130 surrounding the cigarette insertion space 160. Although the temperature change sensing portion 910′ is omitted for intuitive understanding of the drawings, it will be apparent to those skilled in the art that the temperature change sensing portion 910′ is located close to the variable resistor R1 (910) in an actual implementation example.

In order for the resistance change of the variable resistor R1 (910) to be immediately reflected to the MCU 110, the variable resistor R1 (910) may be electrically connected to the PCB 11 located at the bottom of the aerosol-generating device through a wire, and the MCU 110 may determine a detection result of the temperature sensors installed in the airflow path based on a change in the resistance of the variable resistor R1 (910) and recognize that a user's puff has occurred.

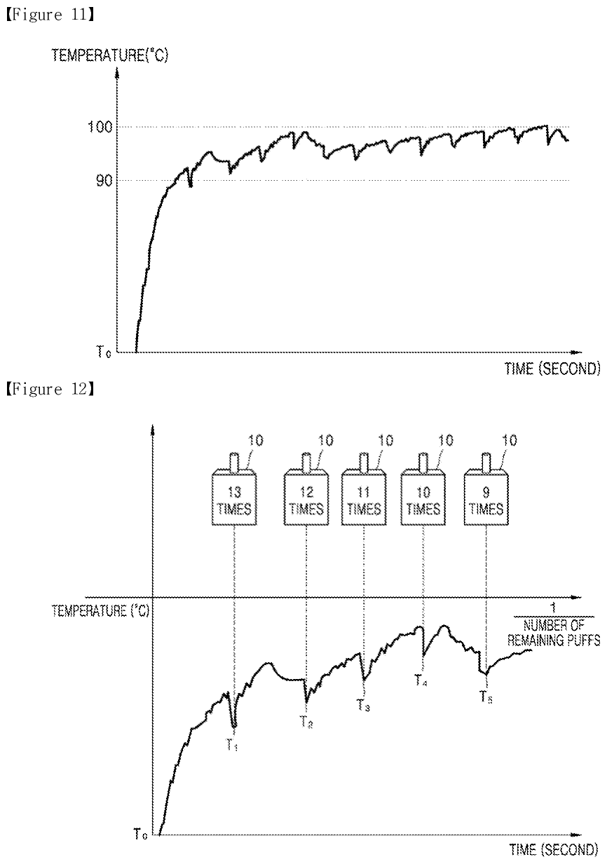

FIG. 11 is a graph showing a temperature change of a temperature sensor that detects a temperature change of air in an airflow path.

Referring to FIG. 11, the temperature of the air flowing in the airflow path starts at T₀ and rises up to around 100 degrees Celsius. For convenience of description, it is assumed that the preheating of the heater 130 is completed at a point where the temperature of the air is 90 degrees Celsius.

Referring to FIG. 11, the temperature of the air inside the airflow path tends to be kept constant within a tolerable error range after the preheating of the heater 130 is completed. In the meantime, whenever a user performs a puff, the temperature of the air inside the airflow path tends to sharply drop. When the MCU 110 recognizes that a puff has occurred, the MCU 110 controls the duty ratio of power supplied to the heater 130 or performs control to quickly recover the temperature of the heater 130 which has sharply dropped, through a proportional integral differential (PID) control method.

FIG. 12 is a view illustrating the number of remaining puffs which is output through an output unit of an aerosol generating device.

More specifically, FIG. 12 is a multigraph in which a graph showing the number of remaining puffs is merged with a graph showing a temperature of a second temperature sensor (i.e., air temperature sensor).

Shown in the upper portion of FIG. 12 is the aerosol-generating device 10 outputting the number of remaining puffs through the output unit disposed on the front side of the aerosol-generating device 10. It is assumed that 14 puffs are provided per one session of the aerosol-generating device of FIG. 12, and the number of remaining puffs tends to gradually decrease with time. In order to clearly express the mathematical meaning, the x-axis in the upper graph of FIG. 12 is marked with ‘1/number of remaining puffs’, and the x-axis is considered to be log-scaled.

Shown in the lower portion of FIG. 12 is a graph showing a temperature change detection result of the second temperature sensor (i.e., an air temperature sensor) according to time.

First, the temperature of the air in the airflow path detected by the second temperature sensor starts from an initial temperature T₀ and continues to rise until the preheating is complete. As a user's first puff occurs at T₁, the temperature of the air inside the airflow path sharply drops. After that, the temperature of the air detected by the second temperature sensor sharply drops whenever a user's puff is detected from T₂ to T₅.

The MCU 110 receives a detection result of a temperature change of each of the plurality of air temperature sensors and determines that a puff has occurred. Accordingly, immediately after the temperature drops to T₁, the MCU 110 changes the number of remaining puffs displayed on the output unit of the aerosol-generating device 10 from 14 to 13. Accordingly, a user may recognize that the remaining number of times the user may inhale an aerosol having consistent quality is now 13. After that, the user may visually confirm through the output unit that the number of remaining puffs is sequentially changed to 12, 11, 10, and 9 as the temperature sensed by the air temperature sensor changes from T₂ through T₅.

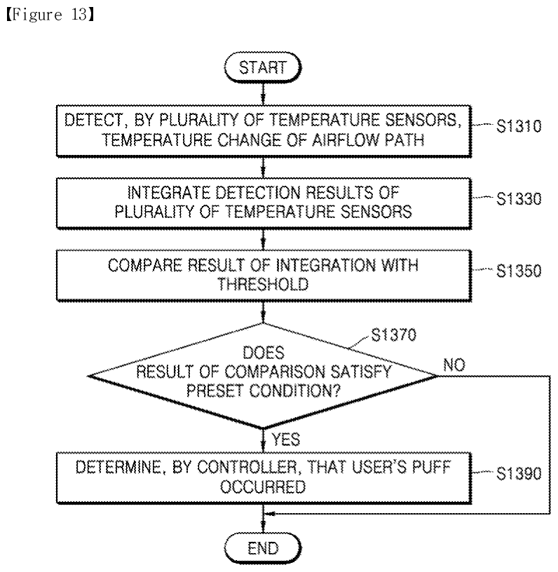

FIG. 13 is a flowchart of an example of a puff recognition method according to an embodiment of the present disclosure.

The puff recognition method of FIG. 13 may be implemented through the aerosol-generating device 10 described above. Therefore, hereinafter, the puff recognition method will be described with reference to FIGS. 1 to 12, and descriptions that are the same as those previously given above will be omitted.

First, a temperature change of the airflow path is detected by a plurality of temperature sensors (operation S1310). In operation S1310, each of the temperature sensors may be a heater temperature sensor or an air temperature sensor.

The controller 110 integrates detection results of the plurality of temperature sensors (operation S1330), and compares a result of the integration with a threshold (operation S1350). The controller 110 determines whether or not a result of the comparison satisfies a preset condition (operation S1370) If the result of the comparison satisfies the preset condition, it is determined that a user's puff has occurred (operation S1390). In an embodiment, in operation S1330, the controller 110 may compare a threshold individually set for each of the plurality of temperature sensors with a temperature change result detected by the corresponding temperature sensor, and determine whether a puff has occurred based on a result of the comparison.

According to the present disclosure, by installing a plurality of temperature sensors inside the airflow path and analyzing results detected by the temperature sensors in an integrated manner, a puff (i.e., inhalation) may be accurately recognized regardless of the intrinsic characteristics of a user's inhalation action.

In addition, according to the present disclosure, the number of puffs may be counted accurately, and thus a consistent aerosol quality may be maintained. For example, based on the accumulated number of puffs, an aerosol-generating device may output a notification to the user before the aerosol quality deteriorates due to the excessive number of puffs.

The embodiments of the present disclosure may be implemented in the form of a computer program which may be executed on a computer via various types of components, and such a computer program may be recorded on a computer-readable recording medium. The medium may include a magnetic medium such as a hard disk, a floppy disk, and a magnetic tape, an optical recording medium such as CD-ROM and DVD, a magneto-optical medium such as a floptical disk, and a hardware device specifically configured to store and execute program instructions, such as ROM, RAM, and flash memory.

The computer program is specifically designed and configured for the present disclosure but may be known to and used by one of ordinary skill in the computer software field. Examples of the computer program may include a high-level language code which may be executed using an interpreter or the like by a computer, as well as a machine language code such as that made by a complier.

The specific implementations described in the present disclosure are example embodiments and do not limit the scope of the present disclosure in any way. For brevity of the specification, descriptions of existing electronic configurations, control systems, software, and other functional aspects of the systems may be omitted. Connections of lines or connection members between components illustrated in the drawings illustratively show functional connections and/or physical or circuit connections and may be represented as alternative or additional various functional connections, physical connections, or circuit connections in an actual device. Unless specifically mentioned, such as “essential”, “importantly”, etc., the components may not be necessary components for application of the present disclosure.

As used herein (in particular, in claims), use of the term “the” and similar indication terms may correspond to both singular and plural. When a range is described in the present disclosure, the present disclosure may include the invention to which individual values belonging to the range are applied (unless contrary description), and each individual value constituting the range is the same as being described in the detailed description of the disclosure. Unless there is an explicit description of the order of the steps constituting the method according to the present disclosure or a contrary description, the steps may be performed in an appropriate order. The present disclosure is not necessarily limited to the description order of the steps. The use of all examples or example terms (for example, etc.) is merely for describing the present disclosure in detail, and the scope of the present disclosure is not limited by the examples or the example terms unless the examples or the example terms are limited by claims. It will be understood by one of ordinary skill in the art that various modifications, combinations, and changes may be made according to the design conditions and factors within the scope of the appended claims or equivalents thereof.

1. An aerosol-generating device comprising:
a plurality of temperature sensors configured to detect a temperature change of an airflow path in the aerosol-generating device; and
a controller configured to compare the detected temperature change with a threshold set for each of the plurality of temperature sensors when the temperature change is detected, and determine whether a user's puff occurred based on a comparison result.

2. The aerosol-generating device of claim 1, wherein at least one of the plurality of temperature sensors is configured to detect an air temperature change in the airflow path.

3. The aerosol-generating device of claim 1, wherein at least one of the plurality of temperature sensors is configured to detect a temperature change of a heater.

4. The aerosol-generating device of claim 3, wherein the heater includes a susceptor that is inductively heated by a coil through which an alternating current flows.

5. The aerosol-generating device of claim 1, wherein the plurality of temperature sensors include at least one air temperature sensor configured to detect an air temperature change in the airflow path, and at least one heater temperature sensor configured to detect a temperature change of a heater.

6. The aerosol-generating device of claim 1, wherein the plurality of temperature sensors include an air temperature sensor configured to detect an air temperature change in the airflow path, and
wherein the air temperature sensor is installed where a range of temperature change by a user's puff in the airflow path is about 3 degrees to about 5 degrees Celsius.

7. The aerosol-generating device of claim 1, further comprising an output unit that visually outputs a number of remaining puffs,
wherein the controller is further configured to determine whether a user's puff occurred and control the output unit to output the number of remaining puffs.

8. The aerosol-generating device of claim 1, wherein the plurality of temperature sensors are configured to selectively detect a change in an air temperature exceeding a preset value.

9. An aerosol-generating device comprising:
a plurality of temperature sensors configured to detect a temperature change of an airflow path in the aerosol-generating device; and
a controller configured to integrate the detected temperature changes of the plurality of temperature sensors, compare an integration result with a preset threshold, and determine whether a user's puff occurred based on a comparison result.

10. A puff recognition method of an aerosol-generating device, the puff recognition method comprising:
detecting, by a plurality of temperature sensors, a temperature change of an airflow path in the aerosol-generating device;
when the temperature change is detected, comparing, by a controller, the detected temperature change with a threshold set for each of the plurality of temperature sensors; and
determining, by the controller, whether a user's puff occurred based on a comparison result.

11. The puff recognition method of claim 10, wherein at least one of the plurality of temperature sensors is configured to detect an air temperature change in the airflow path.

12. The puff recognition method of claim 10, wherein at least one of the plurality of temperature sensors is configured to detect a temperature change of a heater.

13. The puff recognition method of claim 10, wherein the plurality of temperature sensors include at least one air temperature sensor configured to detect an air temperature change in the airflow path, and at least one heater temperature sensor configured to detect a temperature change of a heater.

14. The puff recognition method of claim 10, wherein the plurality of temperature sensors include an air temperature sensor configured to detect an air temperature change in the airflow path, and
wherein the air temperature sensor is installed where a range of temperature change by a user's puff in the airflow path is about 3 degrees to about 5 degrees Celsius.

15. The puff recognition method of claim 10, wherein the plurality of temperature sensors are configured to selectively detect a change in an air temperature exceeding a preset value.
